(19) United States
(12) Patent Application Publication
(10) Pub. No.: US 2006/0242618 A1
(43) Pub. Date: Oct. 26, 2006

(54) Lithographic simulations using graphical processing units

(76) Inventors: Yao-Ting Wang, Santa Clara, CA (US); Chi-Ming Tsai, Santa Clara, CA (US); Fang-Cheng Chang, Santa Clara, CA (US)

Correspondence Address: COURTNEY STANIFORD & GREGORY LLP, P.O. BOX 9686, SAN JOSE, CA, 95157, US

(21) Appl. No.: 11/354,398

(22) Filed: Feb. 14, 2006

Related U.S. Application Data
(60) Provisional application No. 60/653,245, filed on Feb. 14, 2005.

(51) Int. Cl. G06F 17/50

(52) U.S. Cl. 716/19

(57) ABSTRACT

Systems and methods are provided for programming and running simulation engines of lithographic simulations on GPUs. This integration of lithographic simulations includes the hosting on one or more GPUs of any of a variety of lithographic techniques, including for example resolution enhancement technologies, optical proximity correction, optical rule-checking or lithography checking, and model-based DRC, where operations of one or more techniques are run in parallel. The systems and methods provided also include the integration of lithographic geometry operations into GPUs to obtain improved performance. Examples of this integration include a Design Rule Checker (DRC), parasitic extraction, and placement and route for example.

### RELATED APPLICATION

This application claims the benefit of U.S. Patent Application No. 60/653,245, filed Feb. 14, 2005.

### TECHNICAL FIELD

The disclosure herein relates generally to fabricating integrated circuits. In particular, this disclosure relates to systems and methods for performing simulations used in the design and manufacturing of integrated circuit devices or chips.

### BACKGROUND

The need to manufacture integrated circuits (“IC”) at dimensions ever closer to the fundamental resolution limits of optical lithography systems has made resolution enhancement technologies (“RET”) an integral part of the strategic lithography road map for most very-large-scale integrated (“VLSI”) circuit manufacturers. No longer considered research oriented lithography tricks, these techniques are improving lithography process windows to a point where the current pace of chip integration can not be maintained until non-optical lithography solutions become feasible.

In current manufacturing processes, the application of RET (e.g., Off Axis Illumination (“OAI”), Optical Proximity Correction (“OPC”), Phase-Shifting Masks (“PSM”)) to sub-wavelength designs has become a necessary part of manufacturing following tapeout. The RET is necessary in order to make sure that the lithographically printed shapes are as close as possible to the originally targeted, designed layout shapes. In order to assure shape closure through detail simulation of lithographic processes at the tapeout stage before providing a design to a fabrication facility or foundry, detail simulations of the lithographic process models and/or RET recipes must be completed. While this is expensive from a computational point of view, it is also difficult to achieve efficiently using conventional central processing units (CPUs) because of the complexity of the physics and therefore the computations that constrain the design on silicon. Consequently, there is a need for systems and methods that enable circuit designers to efficiently predict and determine the RET-ability or lithographic manufacturability of a circuit design layout.

Self-contained powerful processing units are now available that provide on-chip memory, extensive computation capabilities, and parallelism. These processing units are found in graphics chips that are referred to as Graphical Processing Units (GPUs). The GPUs are known as the responsible entities for drawing the fast moving images observed on computer screens. To achieve those real-time realistic animations, the GPUs must perform many floating-point operations per second. As such, and given that the work performed by the GPUs is dedicated to these applications, the GPUs are forced to offer many more computational resources than the general purpose processors (e.g. CPU). As a result of the processing power available in GPUs, non-graphic applications are beginning to be processed on GPUs. A determinant factor in the development of the latest GPUs is that they are now programmable, offering the capability of executing user's code. This programmability has thus opened the power of the GPU for other non-graphics applications, referred to as General Purpose computation on Graphical Processing Units (GPGPU). The GPGPU for example makes available a generic compiler to translate C-like code into GPU machine instructions (http://www.gpgpu.org). However, because the GPU is aimed at computer graphics, the concepts in GPU-programming are based on computer graphics terminology, and the strategies for programming have to be based on the architecture of the graphics pipeline. Consequently, there is a need for systems and methods that provide for the running of lithographic simulations on GPUs (e.g. GPGPUs).

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a LSGPU performing parallel lithographic simulation operations Tₓ (where X represents an integer 1, 2, . . . , N), under an embodiment.

FIG. 2 is a block diagram of a LSGPU that includes multiple GPUs (e.g., LSGPU₁, . . . , LSGPU_{K}, where K is an integer), under an embodiment.

FIG. 3 is another block diagram of a LSGPU, under an embodiment.

FIG. 4 is a flow diagram for performing lithographic simulation and/or geometry operations using a GPU, under an embodiment.

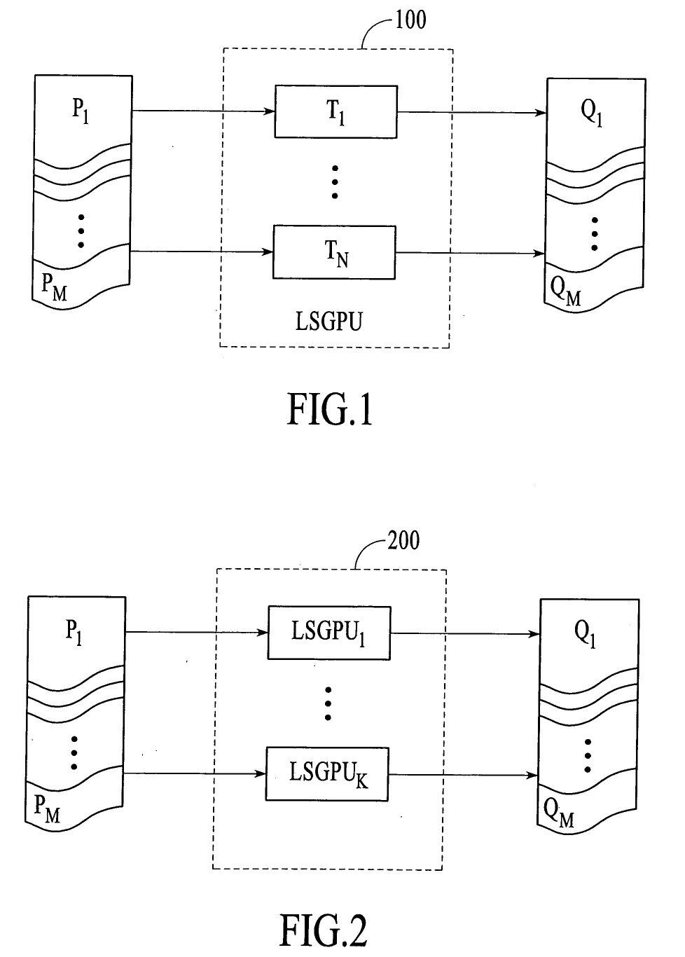

In the drawings, the same reference numbers identify identical or substantially similar elements or acts. To easily identify the discussion of any particular element or act, the most significant digit or digits in a reference number refer to the Figure number in which that element is first introduced (e.g., element 100 is first introduced and discussed with respect to FIG. 1).

### DETAILED DESCRIPTION

Systems and methods are described below for programming and running simulation engines of lithographic simulations on GPUs. This integration of lithographic simulations with GPUs results in a Lithographic Simulation GPU (LSGPU), where the LSGPU includes the hosting of any of a variety of lithographic techniques, including for example resolution enhancement technologies, optical proximity correction, optical rule-checking or lithography checking, and model-based DRC to name a few. The use of LSGPUs for hosting various lithographic simulations provides accelerated performance as a result of parallelism at the chip level (and/or across multiple GPUs). Conventional lithographic simulators are well suited for integration on GPUs because of their ease for parallelism, whether the simulation is based on some mathematical transformation (e.g., Fourier Transforms), and/or lookup table approach (e.g., Optimal Coherence Decomposition or Sum of Coherent Systems). Therefore, the tightly coupled parallelism of the lithographic simulations lends to potentially far more superior performance than clustered-based computation, where the coupling is at the network level rather than at the motherboard (PCB) level. In addition, the combination of clustering and multiple LSGPUs within each motherboard can push the lithographic simulation speed even further.

The LSGPU of an embodiment includes the integration of geometry (polygon) operation-based tools into LSGPUs to obtain improved performance. Examples of this integration include applications in Design Rule Checking (DRC), parasitic extraction, and placement and route, etc. Integration of lithographic geometry operations into the LSGPU is facilitated because the conventional GPU is optimized for polygonal operations for display purpose. Different methods of using one or more LSGPUs range from programming a simple video card, to building a customized PC interface card with one or more GPUs, to adding multiple PC interface cards to one computer, to multiple computers (e.g., clusters) with multiple GPUs interfaced with each computer as is known in the art.

In the following description, numerous specific details are introduced to provide a thorough understanding of, and enabling description for, embodiments of the LSGPU. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments of the LSGPU.

FIG. 1 is a block diagram of a LSGPU 100 performing parallel lithographic simulation operations Tₓ (where X represents an integer 1, 2, . . . , N), under an embodiment. The LSGPU 100 of an embodiment includes a single GPU and a number N of pipelines or channels (e.g. T₁ . . . T_{N}) for use in processing instructions or components of a lithographic simulation equation in parallel, but is not limited to a single GPU or to any particular number of channels. An application of an embodiment divides the problem into M constituents or components (e.g. P₁ . . . P_{M}), and processes each of the M components in parallel (M may be greater than N) to generate (Q₁ . . . Q_{M}) results. For application in the lithography domain, one embodiment of such an application includes a lithography simulation engine. For example, an optical lithography system can be broken down into sum of coherence systems (see for example Y. C. Pati, et. al., Journal of Optical Society of America A 1994) as:

$$I ( x , y ) = {\sum }_{j = 1}^{M} {‖ {h}_{j} ( x , y ) * b ( x , y ) ‖}^{2} \qquad ( Equation 1 )$$

where the desired result is I(x,y) the intensity. The quantity hⱼ(x,y) represents M kernels of the lithography system, b(x,y) represents the input to the system, in this case, a photomask, and “*” represents a two-dimensional (2D) linear convolution. Therefore, for each computation point (x,y), the problem can be broken into M components or jobs, and each job is to compute a piece in Equation 1 as:
hⱼ(x, y) * b(x, y).

The resulting M components are provided as inputs to the N processing pipelines or channels of the LSGPU 100. Each channel of the LSGPU 100 performs the convolution between a single kernel, hⱼ(x,y), and the photomask function, b(x,y). The results of the parallel convolution operations of the LSGPU 100 are stored to (Q₁ . . . Q_{M}). The intensity at any point (x,y) can then be calculated as

$$I = {\sum }_{j = 1}^{M} {‖ {Q}_{j} ‖}^{2}$$

The LSGPU 100 therefore increases the speed of the computations approximately M times when compared to non-parallel processing of conventional CPUs. The LSGPU 100 described above can be used to process any number or type of lithography-based applications, such as, silicon verification, optical proximity correction, etc. Also, as b(x,y) represents the geometry with which a component is convolved, the LSGPU 100 can be used for processing geometry operations such as physical verification (DRC), RC extraction, etc.

As another example, the LSGPU of an embodiment can be used to process components and parameters of a design-to-silicon model that is a “lumped model” that models the RET process and the wafer printing process. The lumped model includes processes to characterize the behavior of the RET and wafer printing processes of the conventional VLSI production flow. The RET process characterized in the lumped model may be any of a number of processes known in the art including but not limited to any number of OPC processes and any number of PSM processes. The lumped design-to-silicon model is generated using optimization that includes minimization of the differences between the lumped model and the identity (circuit design), but is not so limited. One example of a lumped model that models the RET process and the wafer printing process is described in U.S. patent application Ser. No. 11/096,469, filed Apr. 1, 2005.

As described above, the LSGPU of an embodiment is not limited to a single GPU, and alternative embodiments of the LSGPU can include any number of GPUs. FIG. 2 is a block diagram of a LSGPU 200 that includes multiple GPUs (e.g., LSGPU₁, . . . , LSGPU_{K}, where K is an integer), under an embodiment. Each LSGPU performs parallel lithographic simulation operations (e.g. operations Tₓ (where X represents an integer 1, 2, . . . , N) as described above with reference to LSGPU 100), but is not so limited. Thus, for example when M is greater than N, the processes of LSGPU 100 described above are replicated across K different GPUs, so the effective speed increase of processing operations performed by LSGPU 200 is approximately NXK times that of a conventional CPU.

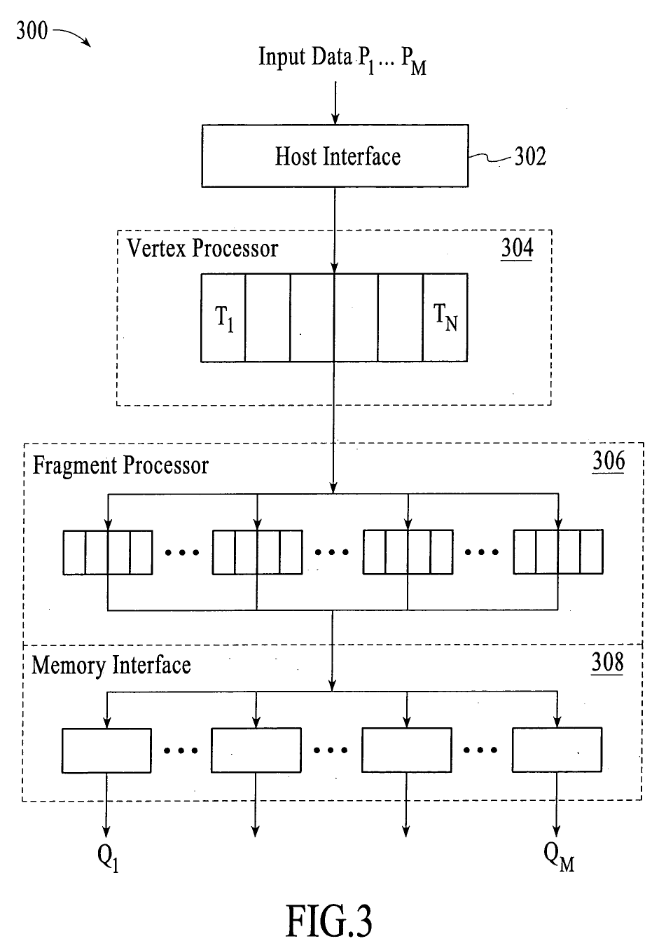

FIG. 3 is a block diagram of a LSGPU, under an embodiment. The LSGPU offers a large degree of parallelism at a relatively low cost. The operations of the LSGPU are similar to the vector processing model, also known as Single Instruction, Multiple Data (SIMD) processing. The LSGPU of an embodiment includes two different types of processing units or pipelines that are programmable stages referred to as a vertex processor (pipeline) 304 and a fragment processor (pipeline) 306. This terminology comes from the graphics operations for which each processor is responsible but in no way limits the processing of the LSGPU to graphics data processing. The programmable configuration of the vertex processor 304 and fragment processor 306, along with their capability for higher precision arithmetic, allows the channels of the LSGPU to be used for parallel stream processing operations of lithographic simulations by programming the vertex processor 304 and/or the fragment processor 306 as appropriate to a particular lithographic simulation operation to be performed. Each of the vertex processor 304 and the fragment processor 306 can have a different number of processing pipelines. One example of a fragment processor 306 of an embodiment includes sixteen (16) pipelines, each of which can handle four (4) floating point operations in parallel, but the embodiment is not so limited. In addition to the processors 304 and 306 the LSGPU of an embodiment can include a host interface 302 and a memory interface 308 that includes read-only and write-only memory interfaces.

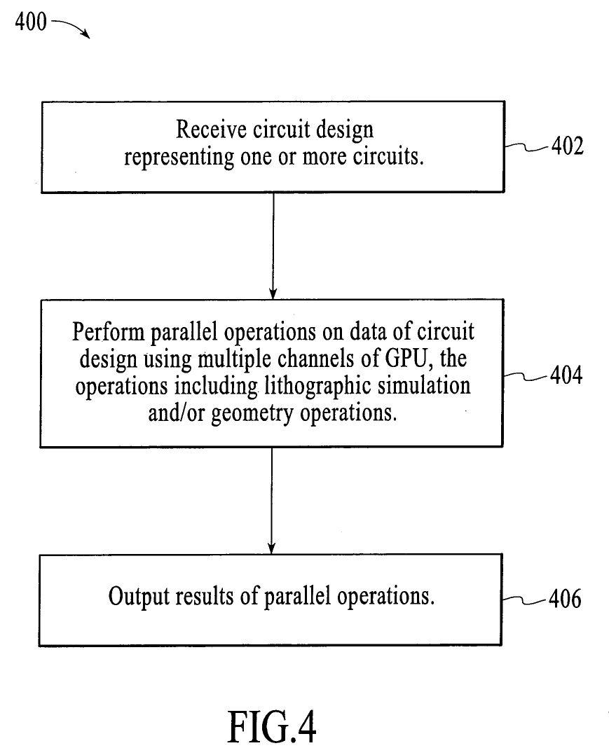

FIG. 4 is a flow diagram 400 for performing lithographic simulation and/or geometry operations using a GPU, under an embodiment. A circuit design that represents at least one circuit is received at 402. Parallel processing operations are performed 404 using multiple channels of a GPU. The parallel processing operations include one or more of lithographic simulation operations and geometry operations but are not so limited. Results of the parallel operations are outputted 406 for use in one or more subsequent operations.

The LSGPU of an embodiment includes a method comprising receiving a circuit design that represents at least one circuit. The method of an embodiment comprises performing in parallel a plurality of operations on data of the circuit design using a plurality of channels of a graphics processing unit, the plurality of operations including one or more of lithographic simulation operations and geometry operations. The method of an embodiment includes outputting results of the plurality of operations for use in at least one subsequent operation.

The lithographic simulation operations of an embodiment include operations under at least one resolution enhancement technology (RET) model.

The lithographic simulation operations of an embodiment include one or more of optical proximity correction and silicon verification.

The geometry operations of an embodiment include one or more of physical verification, design rule checking, circuit parameter extraction, and placement and route.

The performing in parallel of a plurality of operations of an embodiment includes convolving data of a photomask programmed into each of the plurality of channels with one of a plurality of kernels of a lithography system input into each of the plurality of channels.

The method of an embodiment includes generating predicted silicon contours corresponding to the circuit design using information of the results.

The LSGPU of an embodiment includes a device comprising an input interface and a graphics processing unit (GPU) coupled to the input interface. The GPU of an embodiment includes a first processor and a second processor. Each of the first processor and the second processor of an embodiment are configured to include a plurality of channels that execute parallel stream processing of a plurality of operations on received data of a circuit design. The operations of an embodiment include one or more of lithographic simulation operations and geometry operations.

The device of an embodiment includes a memory interface coupled to the GPU, wherein the memory interface receives data resulting from the parallel stream processing.

The first processor of an embodiment is a vertex processor and the second processor is a fragment processor.

The lithographic simulation operations of an embodiment include operations under at least one resolution enhancement technology (RET) model.

The geometry operations of an embodiment include one or more of physical verification, design rule checking, circuit parameter extraction, and placement and route.

The parallel stream processing of the plurality of operations of an embodiment is configured to include convolving data of a photomask programmed into each of the plurality of channels with one of a plurality of kernels of a lithography system input into each of the plurality of channels.

The device of an embodiment includes a generator coupled to the GPU that is configured to generate predicted silicon contours corresponding to the circuit design using information of data resulting from the parallel stream processing.

The LSGPU of an embodiment includes a computer readable medium including executable instructions which when executed by processors of a system receive a circuit design that represents at least one circuit and perform in parallel a plurality of operations on data of the circuit design using a plurality of channels of a graphics processing unit, the plurality of operations including one or more of lithographic simulation operations and geometry operations. The computer readable medium of an embodiment outputs results of the plurality of operations for use in at least one subsequent operation.

The lithographic simulation operations of an embodiment include operations under at least one resolution enhancement technology (RET) model.

The lithographic simulation operations of an embodiment include one or more of optical proximity correction and silicon verification.

The geometry operations of an embodiment include one or more of physical verification, design rule checking, circuit parameter extraction, and placement and route.

The performing in parallel a plurality of operations of an embodiment includes convolving data of a photomask programmed into each of the plurality of channels with one of a plurality of kernels of a lithography system input into each of the plurality of channels.

The instructions of an embodiment, when executed by the processors, generate predicted silicon contours corresponding to the circuit design using information of the results.

Aspects of the LSGPU described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the LSGPU include: microcontrollers with memory (such as electronically erasable programmable read only memory (EEPROM)), embedded microprocessors, firmware, software, etc. Furthermore, aspects of the LSGPU may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the various systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages.

Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs including, without limitation, net-list generation programs, place and route programs and the like.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the LSGPU is not intended to be exhaustive or to limit the LSGPU to the precise form disclosed. While specific embodiments of, and examples for, the LSGPU are described herein for illustrative purposes, various equivalent modifications are possible within the scope of the LSGPU, as those skilled in the relevant art will recognize. The teachings of the LSGPU provided herein can be applied to other processing systems and methods, not only for the LSGPUs described above.

The elements and acts of the various embodiments described above can be combined to provide further embodiments. These and other changes can be made to the LSGPU in light of the above detailed description.

In general, in the following claims, the terms used should not be construed to limit the LSGPU to the specific embodiments disclosed in the specification and the claims, but should be construed to include all systems and methods that operate under the claims. Accordingly, the LSGPU is not limited by the disclosure, but instead the scope of the LSGPU is to be determined entirely by the claims.

While certain aspects of the LSGPU are presented below in certain claim forms, the inventors contemplate the various aspects of the LSGPU in any number of claim forms. For example, while only one aspect of the system may be recited as embodied in machine-readable medium, other aspects may likewise be embodied in machine-readable medium. Accordingly, the inventors reserve the right to add additional claims after filing the application to pursue such additional claim forms for other aspects of the LSGPU.

What is claimed is:

1. A method comprising:
receiving a circuit design that represents at least one circuit;
performing in parallel a plurality of operations on data of the circuit design using a plurality of channels of a graphics processing unit, the plurality of operations including one or more of lithographic simulation operations and geometry operations; and
outputting results of the plurality of operations for use in at least one subsequent operation.

2. The method of claim 1, wherein the lithographic simulation operations include operations under at least one resolution enhancement technology (RET) model.

3. The method of claim 1, wherein the lithographic simulation operations include one or more of optical proximity correction and silicon verification.

4. The method of claim 1, wherein the geometry operations include one or more of physical verification, design rule checking, circuit parameter extraction, and placement and route.

5. The method of claim 1, wherein performing in parallel a plurality of operations includes convolving data of a photomask programmed into each of the plurality of channels with one of a plurality of kernels of a lithography system input into each of the plurality of channels.

6. The method of claim 1, further comprising generating predicted silicon contours corresponding to the circuit design using information of the results.

7. A device comprising:
an input interface; and
a graphics processing unit (GPU) coupled to the input interface, the GPU including a first processor and a second processor, wherein each of the first processor and the second processor are configured to include a plurality of channels that execute parallel stream processing of a plurality of operations on received data of a circuit design, the plurality of operations including one or more of lithographic simulation operations and geometry operations.

8. The device of claim 7, further comprising a memory interface coupled to the GPU, wherein the memory interface receives data resulting from the parallel stream processing.

9. The device of claim 7, wherein the first processor is a vertex processor and the second processor is a fragment processor.

10. The device of claim 7, wherein the lithographic simulation operations include operations under at least one resolution enhancement technology (RET) model.

11. The device of claim 7, wherein the geometry operations include one or more of physical verification, design rule checking, circuit parameter extraction, and placement and route.

12. The device of claim 7, wherein the parallel stream processing of the plurality of operations is configured to include convolving data of a photomask programmed into each of the plurality of channels with one of a plurality of kernels of a lithography system input into each of the plurality of channels.

13. The device of claim 7, further comprising a generator coupled to the GPU that is configured to generate predicted silicon contours corresponding to the circuit design using information of data resulting from the parallel stream processing.

14. A computer readable medium including executable instructions which when executed by processors of a system:
receive a circuit design that represents at least one circuit;
perform in parallel a plurality of operations on data of the circuit design using a plurality of channels of a graphics processing unit, the plurality of operations including one or more of lithographic simulation operations and geometry operations; and
output results of the plurality of operations for use in at least one subsequent operation.

15. The computer readable medium of claim 14, wherein the lithographic simulation operations include operations under at least one resolution enhancement technology (RET) model.

16. The computer readable medium of claim 14, wherein the lithographic simulation operations include one or more of optical proximity correction and silicon verification.

17. The computer readable medium of claim 14, wherein the geometry operations include one or more of physical verification, design rule checking, circuit parameter extraction, and placement and route.

18. The computer readable medium of claim 14, wherein performing in parallel a plurality of operations includes convolving data of a photomask programmed into each of the plurality of channels with one of a plurality of kernels of a lithography system input into each of the plurality of channels.

19. The computer readable medium of claim 14, wherein the instructions, when executed by the processors, generate predicted silicon contours corresponding to the circuit design using information of the results.
